(19) United States
(12) Patent Application Publication
(10) Pub. No.: US 2009/0304089 A1
(43) Pub. Date: Dec. 10, 2009

(54) Reproduction processing apparatus, reproduction processing method, and computer program

(75) Inventors: Tsutomu Seki, Chiba (JP); Toshiharu Yabe, Tokyo (JP); Hiroshige Okamoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/455,327

(22) Filed: Jun. 1, 2009

(30) Foreign Application Priority Data
Jun. 5, 2008 (JP) P2008-148208

(51) Int. Cl. H04N 7/26

(52) U.S. Cl. 375/240.25; 375/E07.2

(57) ABSTRACT

A reproduction processing apparatus includes: a decoding unit that executes decoding processing for coded data; a decoding-processing scheduling unit that sets a sequence of the decoding processing in the decoding unit; and a display-frame selecting unit that selects a display frame from a decoding result in the decoding unit. The decoding-processing scheduling unit sets a sequence of decoding target data necessary for display of display-scheduled frames in future and sequentially sets, according to the sequence, queues for the decoding unit when vacancy of a queue occurs, and the display-frame selecting unit checks a completion state of decoding of the display-scheduled frame at every display timing and, when the decoding is not completed, performs processing for selecting a decoded frame near the display-scheduled frame as a display frame.

The present application claims priority from Japanese Patent Application No. JP 2008-148208 filed in the Japanese Patent Office on Jun. 5, 2008, the entire content of which is incorporated herein by reference.

### BACKGROUND OF THE INVENTION

1. Field of the Invention

The present invention relates to a reproduction processing apparatus, a reproduction processing method, and a computer program, and, more particularly to a reproduction processing apparatus, a reproduction processing method, and a computer program for executing reproduction processing involving decoding processing.

2. Description of the Related Art

For example, when image data is recorded in a recording medium or when the image data is transmitted via a network or the like, compression for reducing a data volume is performed. In data reproduction, the compressed data is decoded (also referred to as expansion or decryption) and reproduced.

For example, a series of MPEG standards based on inter-frame coding (Moving Pictures coding Experts Group: ISO/IEC11172-2, ISO/IEC13818-2, ISO/IEC14496-2) have high cost performance in a compression ratio and an image quality and are adopted in a large number of applications such as digital TV broadcasting, DVD-video and Blu-Ray.

In video coding processing based on the MPEG, the following three kinds of compressed data are generated:

intra-coded frame (hereinafter referred to as I picture); predictive coded frame (hereinafter referred to as P picture); and
bidirectionally predictive coded frame (hereinafter referred to as B picture).

The compressed data as a sequence of GOP (Group Of Pictures) starting from the I picture in most cases are output as a bit stream (hereinafter referred to as stream) in order.

The I (Intra-coded) picture is a frame that can be decoded by using only data of the frame.

The P (Predictive coded) picture is a frame that can be decoded by using data of an I picture or a P picture decoded before the frame and data of the frame.

The B (Bidirectionally predictive coded) picture is a frame that can be decoded by using data of temporally-continuous two I pictures or P pictures and data of the frame.

The B picture is decoded with reference to a frame located behind in display order in decoding. Therefore, when the B picture is coded, the order of frames are changed to code the B picture. Coded data as a sequence of GOP (Group Of Pictures) starting from the I picture in most cases are output as a bit stream (hereinafter referred to as stream) in order.

The I picture and the P picture are decoded without reference to a frame located behind in display order in decoding. Therefore, when the I picture and the P picture are coded, the order of frames is not changed and the frames are decoded in the display order. When an MPEG stream is decoded, after frames are read in coding order from the stream, the MPEG stream is decoded in the coding order. Output of videos is performed in the display order.

However, if decoding processing speed is insufficient with respect to reproducing speed (processing does not catch up with reproduction when all pictures are decoded), it is necessary to decode only necessary pictures.

A general decoding processing example in a reproduction processing apparatus in the past is explained below with reference to a flowchart shown in FIG. 1. In most apparatuses, a processing ability of a decoder is designed such that expansion of a compressed image can be completed in a one-frame display period (in the case of NTSC, 1/29.97 sec) in real time. In such a system, decoding has to be performed as planned.

First, in step S11, the reproduction processing apparatus extracts a decoding processing target picture from MPEG compressed data. This picture is a picture of any one kind among the I, P, and B pictures. In step S12, the reproduction processing apparatus executes the decoding processing for the extracted picture. As described above, a status of the decoding processing executed in step S12 is different in each of the I, P, and B pictures.

When the decoding processing for the picture in step S12 is finished, in step S13, the reproduction processing apparatus stays on standby until decoding of the next picture. Time for the standby corresponds to reproducing speed. The standby time is short when, for example, fast-forward reproduction is executed. Thereafter, in step S14, the reproduction processing apparatus outputs a decoded image to a display device and reproduces the image. After the reproduction and display processing in step S14, the reproduction processing apparatus returns to step S11, extracts the next decoded data, and repeats the same processing.

The decoding processing following the flow shown in FIG. 1 is a processing sequence for executing decoding of all the I, P, and B pictures and reproducing the pictures. However, for example, when high-speed fast-forward reproduction is performed, if the flow shown in FIG. 1 is executed, the decoding may not be able to follow reproducing speed. In order to avoid such a situation, a decoding target picture may be selected to omit the decoding processing for a part of the pictures. For example, JP-A-7-154743 and JP-A-2007-129489 disclose systems that realizes high-speed image reproduction by omitting decoding of the B picture.

A reproduction processing sequence for selecting a decoding target picture to make it possible to perform high-speed reproduction is explained with reference to a flowchart shown in FIG. 2. The flow shown in FIG. 2 is processing for omitting decoding of the B picture or the B picture and the P picture among the I, P, and B pictures to make it possible to follow high-speed reproduction. This processing is referred to as “B skip” or “PB skip”.

First, in step S21, a reproduction processing apparatus extracts a decoding processing target picture from MPEG compressed data. This picture is a picture of any one kind among the I, P, and B pictures. In the next step S22, the reproduction processing apparatus discriminates the type of the extracted picture.

When “B skip” processing is performed, if the extracted picture is the B picture, the reproduction processing apparatus returns to step S21 without executing decoding and selects the next picture.

When “PB skip” processing is performed, if the extracted picture is the P picture or the B picture, the reproduction processing apparatus returns to step S21 without executing decoding and selects the next picture.

Pictures to be extracted when the reproduction processing apparatus proceeds to step S23 and executes decoding are different in the case of the “B skip” processing and in the case of the “PB skip” processing. When the “B skip” processing is performed, the extracted picture is the I picture or the P picture. When the “PB skip” processing is performed, the extracted picture is the I picture.

In step S23, the reproduction processing apparatus executes decoding processing for the extracted picture (the I picture or the I and P pictures). When the decoding processing for the picture in step S23 is finished, in step S24, the reproduction processing apparatus stays on standby until decoding of the next picture. Thereafter, in step S25, the reproduction processing apparatus outputs the decoded image to the display device to reproduce the image. After the reproduction and display in step S25, the reproduction processing apparatus returns to step S21, extracts the next decoded data, and repeats the same processing.

It is possible to perform decoding following high-speed reproduction by selecting a decoding target picture and performing the processing in this way.

In general MPEG data, B pictures are included at a ratio of about two to three pictures. Theoretically, it is possible to realize triple-speed reproduction by performing the B skip without increasing speed of the decoding processing. However, a ratio of B pictures is not determined in the specification of MPEG. B pictures are non-uniformly present.

When the B skip reproduction following the flow shown in FIG. 2 is applied to such a stream, reproducing speed becomes non-uniform. If the P picture and the B picture are skipped (only the I picture is decoded and displayed), reproduction equivalent to about fifteen-fold speed can be performed. In this case, reproducing speed also becomes non-uniform because of non-uniformity of the I picture.

Processing for skipping, when higher-sped fast-forward is realized, n−1 I pictures among n pictures in addition to the PB skip is also proposed. When such processing is performed, high-speed reproduction at about 15×n fold speed is possible. However, in the case of this processing, as reproducing speed, it is necessary to select only speed specified to some extent, i.e., reproducing speed with “n” set to an integer. Therefore, it is difficult to cope with arbitrary reproducing speed.

Further, when reverse-direction reproduction processing is performed, decoding can be performed only in a forward direction starting from the I picture because of the characteristic of the MPEG, it is a general practice to reproduce only the I picture. In this case, a problem same as that in the forward direction occurs in reverse-direction reproduction at fifteen-fold or higher speed. The speed of high-speed reverse-direction reproduction is limited to predetermined speed with “n” set to an integer. Concerning reverse-direction reproduction at speed lower than fifteen-fold speed, it is a simplest and general practice to continue to display the same I picture. However, displayed frames are only sparsely updated.

In addition to the problems, when reproducing speed is changed, it is necessary to change a processing flow of a computer program. Therefore, time lag occurs until the reproducing speed is reflected on the operation by a user.

### SUMMARY OF THE INVENTION

In view of, for example, the problems mentioned above, it is desirable to provide a reproduction processing apparatus, a reproduction processing method, and a computer program for realizing decoding processing and display processing for smoothly performing reproduction processing at various kinds of speed and generating a high-quality reproduced image.

According to an embodiment of the present invention, there is provided a reproduction processing apparatus including: a decoding unit that executes decoding processing for coded data; a decoding-processing scheduling unit that sets a sequence of the decoding processing in the decoding unit; and a display-frame selecting unit that selects a display frame from a decoding result in the decoding unit. The decoding-processing scheduling unit sets a sequence of decoding target data necessary for display of display-scheduled frames in future and sequentially sets, according to the sequence, queues for the decoding unit when vacancy of a queue occurs. The display-frame selecting unit checks a completion state of decoding of the display-scheduled frame at every display timing and, when the decoding is not completed, performs processing for selecting a decoded frame near the display-scheduled frame as a display frame.

In the embodiment, the decoding-processing scheduling unit monitors vacancy of the queue and, when vacancy occurs, sequentially sets queues according to the sequence.

In the embodiment, the decoding-processing scheduling unit sets, in addition to decoding target data necessary for display of the next display-scheduled frame of a presently displayed frame, decoding target data necessary for display of a display-scheduled frame after that as queues for the decoding unit.

In the embodiment, the decoding-processing scheduling unit analyzes a display-scheduled frame at each display interval on the basis of reproducing speed and also sets decoding target data necessary for displaying decoding target data necessary for display of the display-scheduled frame as queues for the decoding unit.

In the embodiment, the coded data is MPEG data including an I picture, a P picture, and a B picture as elements. The decoding-processing scheduling unit discriminates which of the I picture, the P picture, and the B picture the display-scheduled frames in future are and sets a decoding sequence according to a result of the discrimination.

In the embodiment, the coded data is MPEG data including an I picture, a P picture, and a B picture as elements. The decoding-processing scheduling unit acquires decoding prediction time set in association with the I picture, the P picture, and the B picture and sets a decoding sequence according to a type of the decoding target data.

In the embodiment, the display-frame selecting unit performs, when the decoding of the display-scheduled frame is not completed at every display timing, processing for selecting a nearest decoded frame among frames in the past before the display-scheduled frame as a display frame if a display state in the display unit is forward-direction reproduction processing and performs processing for selecting a nearest decoded frame among frames in future after the display-scheduled frame as a display frame if the display state in the display unit is reverse-direction reproduction processing.

In the embodiment, the display-frame selecting unit performs, when the decoding of the display-scheduled frame is not completed at every display timing, display frame selection processing for continuing to display an immediately preceding display frame if the display state in the display unit is a temporary stop state.

According to another embodiment of the present invention, there is provided an integrated circuit including: a decoding unit that executes decoding processing for coded data; a decoding-processing scheduling unit that sets a sequence of the decoding processing in the decoding unit; and a display-frame selecting unit that selects a display frame from a decoding result in the decoding unit. The decoding-processing scheduling unit sets a sequence of decoding target data necessary for display of display-scheduled frames in future and sequentially sets, according to the sequence, queues for the decoding unit when vacancy of a queue occurs. The display-frame selecting unit checks a completion state of decoding of the display-scheduled frame at every display timing and, when the decoding is not completed, performs processing for selecting a decoded frame near the display-scheduled frame as a display frame.

According to still another embodiment of the present invention, there is provided a reproduction processing method executed in a reproduction processing apparatus, the reproduction processing method including the steps of: a decoding unit executing decoding processing for coded data; a decoding-processing scheduling unit setting a sequence of the decoding processing in the decoding unit; and a display-frame selecting unit selecting a display frame from a decoding result in the decoding unit. The decoding-processing scheduling step includes a step of setting a sequence of decoding target data necessary for display of display-scheduled frames in future and sequentially setting, according to the sequence, queues for the decoding unit when vacancy of a queue occurs. The display-frame selecting step includes a step of checking a completion state of decoding of the display-scheduled frame at every display timing and, when the decoding is not completed, performing processing for selecting a decoded frame near the display-scheduled frame as a display frame.

According to still another embodiment of the present invention, there is provided a computer program for causing a reproduction processing apparatus to execute reproduction processing, the computer program including the steps of: a decoding unit executing decoding processing for coded data; a decoding-processing scheduling unit setting a sequence of the decoding processing in the decoding unit; and a display-frame selecting unit selecting a display frame from a decoding result in the decoding unit. The decoding-processing scheduling step includes a step of setting a sequence of decoding target data necessary for display of display-scheduled frames in future and sequentially setting, according to the sequence, queues for the decoding unit when vacancy of a queue occurs. The display-frame selecting step includes a step of checking a completion state of decoding of the display-scheduled frame at every display timing and, when the decoding is not completed, performing processing for selecting a decoded frame near the display-scheduled frame as a display frame.

The computer program according to the embodiment is, for example, a computer program that can be provided to, via a storage medium and a communication medium provided in a computer-readable format, a general-purpose computer system that can execute various program code. By providing such a program in the computer-readable format, processing corresponding to the program can be realized in the computer system.

Other objects, characteristics, and advantages of the present invention will be apparent from the following more detailed explanation based on embodiments of the present invention and the accompanying drawings. The system in this specification is a logical set of plural apparatuses and is not limited to a system in which apparatuses having respective configurations are provided in the same housing.

According to the embodiments of the present invention, for example, in the reproduction processing apparatus, the reproduction processing method, and the computer program for performing decoding processing for MPEG coded data, the decoding-processing scheduling unit sets a sequence of decoding target data necessary for display of display-scheduled frames in future and sequentially sets, according to the sequence, queues for the decoding unit when vacancy of a queue occurs. The display-frame selecting unit checks a completion state of decoding of the display-scheduled frame at every display timing and, when the decoding is not completed, selects a decoded frame near the display-scheduled frame as a display frame. With such a configuration, for example, in high-speed reproduction processing, even when the decoding of the display-scheduled frame is not completed at every display timing, since display of a near frame is executed, high-quality image reproduction processing with little fluctuation is realized.

### BRIEF DESCRIPTION OF THE DRAWINGS

FIG. 1 is a flowchart for explaining an example of general decoding processing in a reproduction processing apparatus in the past;

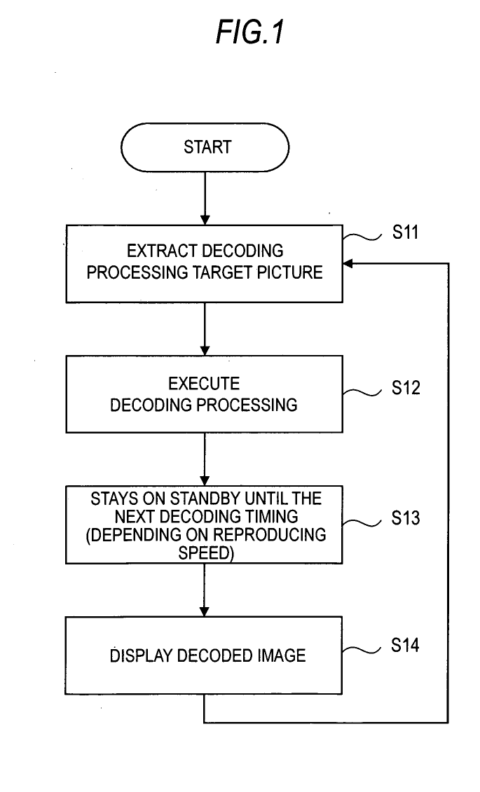

FIG. 2 is a flowchart for explaining a reproduction processing sequence that makes it possible to select a decoding target picture and perform high-speed reproduction;

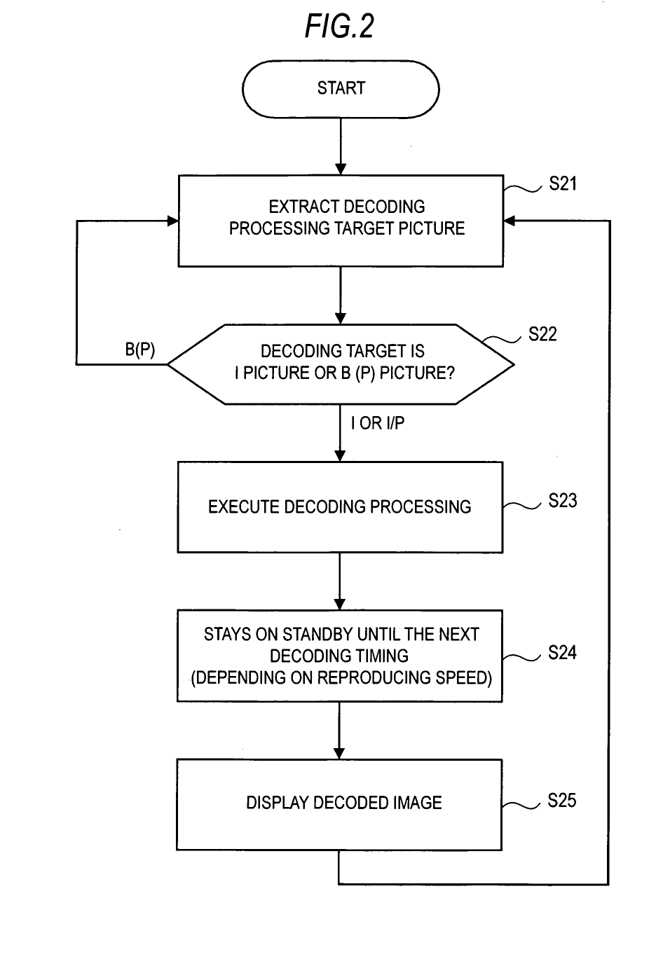

FIG. 3 is a diagram for explaining a configuration example of a reproduction processing apparatus according to an embodiment of the present invention;

FIG. 4 is a diagram for explaining processing executed by a control unit 109, a decoding unit 105, and a display control unit 107 of a reproduction processing apparatus 100 according to the embodiment;

FIG. 5 is a diagram for explaining a specific example of decoding sequence setting executed by the reproduction processing apparatus according to the embodiment;

FIG. 6 is a flowchart for explaining a sequence of display frame selection processing executed by a display-frame selecting unit 213 of the reproduction processing apparatus according to the embodiment;

FIG. 7 is a diagram for explaining an example of processing for selecting a frame nearest to an output-scheduled frame out of decoded frames before the output-scheduled frame and outputting the frame;

FIG. 8 is a diagram for explaining an example of a sequence of decoding and display processing by the reproduction processing apparatus according to the embodiment;

FIG. 9 is a diagram for explaining an example of a sequence of decoding and display processing by the reproduction processing apparatus in the past; and

FIG. 10 is a table of comparison data of differences between display frames and display-scheduled frames in the decoding and display processing by the reproduction processing apparatus according to the embodiment and the decoding and display processing by the reproduction processing apparatus in the past.

### DESCRIPTION OF THE PREFERRED EMBODIMENTS

Details of a reproduction processing apparatus, a reproduction processing method, and a computer program according to an embodiment of the present invention are explained below.

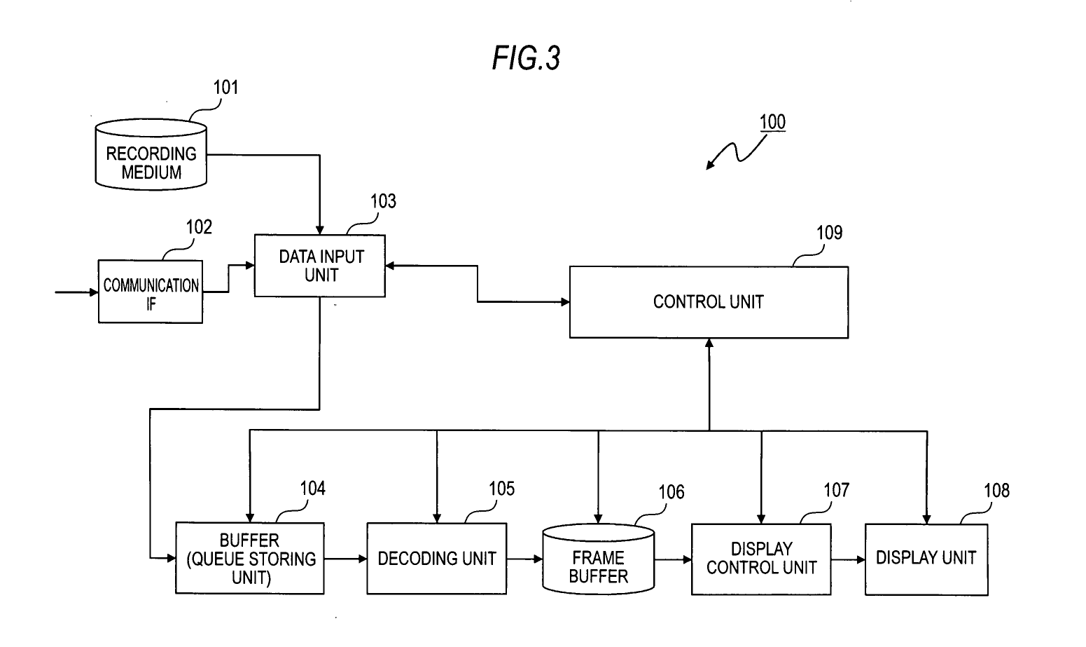

A configuration example of the reproduction processing apparatus according to the embodiment is shown in FIG. 3. A reproduction processing apparatus 100 shown in FIG. 3 performs processing for decoding data stored in a recording medium 101 and data input via a communication IF 102 and displaying the data on a display unit 107. The reproduction processing apparatus 100 includes, as shown in FIG. 3, a recording medium 101, a communication IF 102, a data input unit 103, a buffer (a queue storing unit) 104, a decoding unit 105, a frame buffer 106, a display control unit 107, a display unit 108, and a control unit 109.

The recording medium 101 is, for example, a hard disk or an optical disk. The recording medium 101 records, for example, video data that is inter-frame prediction coded in an MPEG system or the like. The video data and the like can be reproduced from the recording medium 101 at speed higher than normal reproducing speed. The communication IF 102 receives coded data compressed in the MPEG system from the outside via a wireless or wired network.

The data input unit 103 is input with coded data via the recording medium 101 or the communication IF 102 and writes the coded data in the buffer (the queue storing unit) 104. This processing is executed under the control by the control unit 109.

The decoding unit 105 extracts the data written in the buffer (the queue storing unit) 104 and performs decoding processing for the data. For example, the decoding unit 105 executes decoding processing corresponding to each of an I picture, a P picture, and a B picture for reproducing MPEG data.

A decoding result of the decoding unit 105 is stored in the frame buffer 106. The display control unit 107 acquires the decoded frame data from the frame buffer 106 and outputs the frame data to the display unit 108 including an LCD. The display control unit 107 outputs frame data selected according to a set reproduction status such as high-speed reproduction and reverse direction reproduction to the display unit 108 and displays the frame data. The control unit 109 executes the control of the series of processing explained above, i.e., a series of processing such as the setting of queues in the buffer (the queue storing unit) 104, the decoding processing by the decoding unit 105, and the display and reproduction processing by the display control unit 107.

For example, the display unit 108 of the reproduction processing apparatus 100 according to this embodiment displays image frame data of about thirty frames in one second. In the following explanation, a display period for one frame is set to [1/29.97 second]. However, this is only an example for explaining this embodiment. The present invention can be applied in other display statuses.

The decoding unit 105 can decode data of plural frames in the one-frame display period (=1/29.97 sec).

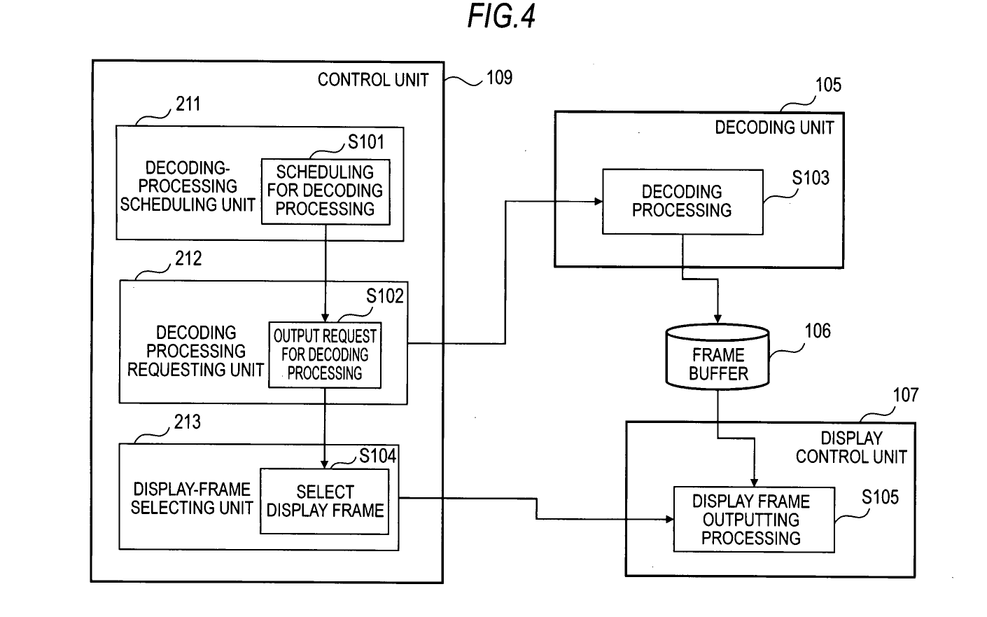

A sequence of processing executed by the control unit 109, the decoding unit 105, and the display control unit 107 of the reproduction processing apparatus 100 according to this embodiment is explained with reference to FIG. 4.

In decoding and reproduction processing executed by the reproduction processing apparatus 100 according to this embodiment, the processing progresses in order of steps S101 to S105 shown in FIG. 4. The control unit 109 includes, as shown in the figure, a decoding-processing scheduling unit 211, a decoding-processing requesting unit 212, and a display-frame selecting unit 213 as functional processing units.

First, in step S101, the decoding-processing scheduling unit 211 of the control unit 109 performs scheduling processing for decoding processing. This processing is processing for selecting a display-scheduled frame that should be displayed in future, setting a sequence of decoding target frames (pictures) necessary for display of the selected frame, and setting queues in the buffer (the queue storing unit) 104 shown in FIG. 3.

For example, when one-frame display time in the display unit 108 is 1/29.97 second, first, the decoding-processing scheduling unit 211 selects display frames after n/29.97 second such as a display frame after 1/29.97 second calculated from a presently displayed frame and reproducing speed and a frame after 2/29.97 second as frames scheduled to be displayed in future. Subsequently, the decoding-processing scheduling unit 211 selects a picture necessary for display of these frames as a decoding target, sets a schedule for the decoding processing, and determines order of the decoding processing. The decoding-processing scheduling unit 211 sets a queue for decoding in the buffer (the queue storing unit) 104 shown in FIG. 3 according to this determination.

As explained above, MPEG coded data includes three kinds of frame data, i.e., an I picture, a P picture, and a B picture.

These coded frames have different decoding processing statuses. In other words, the coded frames have characteristics explained below, respectively.

The I (Intra-coded) picture is a frame that can be decoded by using only data of the frame.

The P (Predictive coded) picture is a frame that can be decoded by using data of an I picture or a P picture decoded before the frame and data of the frame.

The B (Bidirectionally predictive coded) picture is a frame that can be decoded by using data of temporally-continuous two I pictures or P pictures and data of the frame.

Therefore, a decoding sequence is different depending on whether a display-scheduled frame is an I picture, a P picture, or a B picture. The decoding-processing scheduling unit 211 of the control unit 109 sets a sequence for the decoding processing according to a picture type of the display-scheduled frame.

Specifically, if the display-scheduled picture is an I picture, the decoding-processing scheduling unit 211 has to set only the I picture as a decoding target.

However, if the display-scheduled picture is a P picture, the decoding-processing scheduling unit 211 needs to set an I picture or a P picture before the P picture and the P picture as decoding targets.

If the display-scheduled picture is a B picture, the decoding-processing scheduling unit 211 needs to set an I picture or a P picture before and after the B picture and the B picture as decoding targets.

The decoding-processing scheduling unit 211 of the control unit 109 determines a sequence of the decoding processing according to a picture type of the display-scheduled frames and sets queues for decoding in the buffer (the queue storing unit) 104 shown in FIG. 3 according to this determination.

The decoding-processing scheduling unit 211 of the control unit 109 is input with information such as display status information (high-speed reproduction (how many times as high as normal speed), a reproducing direction (a forward direction or a reverse direction), whether the display unit 108 is in a temporary stop state, etc.) in the display unit 108 and determines a decoding sequence taking into account these kinds of information. For example, if high-speed reproduction is quintuple-speed high-speed reproduction, the decoding-processing scheduling unit 211 performs processing for, for example, setting a decoding sequence such that every fifth frames can be displayed.

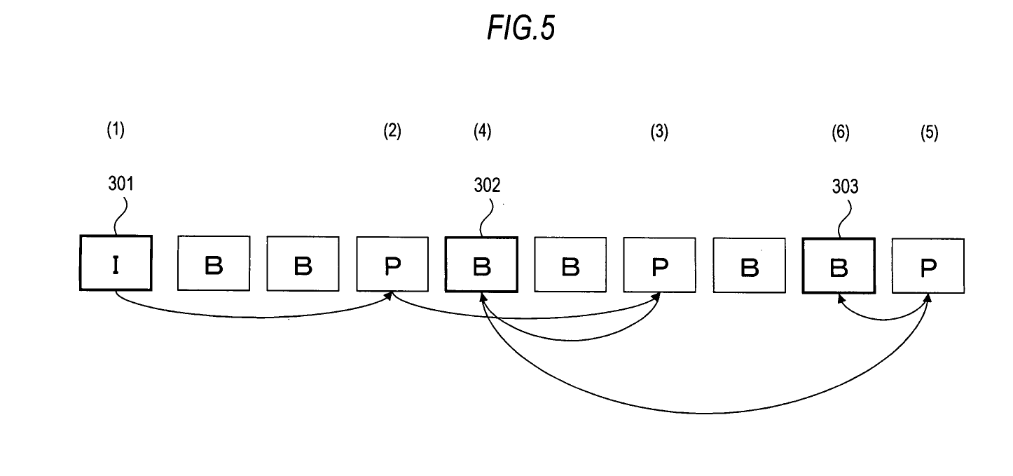

A specific decoding sequence setting example is explained with reference to FIG. 5. For example, it is assumed that, as shown in FIG. 5, pictures corresponding to frames are set in such a manner as IBBPBBPBBPBBP in MPEG data.

If every fifth frames of this MPEG data are selected as display targets and display time for each of the frames is set to 1/29.97 second, quintuple-speed reproduction can be realized. In other words, an I picture 301, a B picture 302, and a B picture 303 only have to be set as display frames.

Concerning the I picture 301, a display frame can be generated by decoding processing for only the I picture 301. However, since the frames 302 and 303 are B pictures, in order to reproduce this B picture, decoding of the I pictures or P pictures before and after the B picture also has to be performed.

In other words, it is necessary to set a sequence for decoding pictures (1) to (6) shown in FIG. 5 in order as a decoding sequence. The decoding-processing scheduling unit 211 of the control unit 109 sets order of decoding processing according to picture types of such display frames.

The decoding-processing scheduling unit 211 of the control unit 109 sets a new queue according to the determined order when there is vacancy in the buffer (the queue storing unit) 104 shown in FIG. 3. In other words, the decoding-processing scheduling unit 211 determines a sequence of decoding target pictures among pictures necessary for displaying a display-scheduled frame after a frame interval sec) calculated from the present reproducing speed and sets queues indicating that the decoding target pictures are decoding waiting pictures in the buffer (the queue storing unit) 104.

In this way, the decoding-processing scheduling unit 211 of the control unit 109 sets a sequence of decoding target data necessary for display of display-scheduled frames in future and sequentially sets, according to the sequence, queues for the decoding unit 105 when vacancy of a queue occurs. According to this processing, the decoding unit 105 can continuously execute the decoding processing without a pause as long as a queue is present.

As explained above, like the B picture and the P picture, when pictures need a reference frame, the decoding-processing scheduling unit 211 selects a picture that needs to be decoded prior to these pictures and sets the picture as a preceding queue. This processing is continued as long as there is vacancy in the buffer (the queue storing unit) 104 shown in FIG. 3. When there is no vacancy in the buffer (the queue storing unit) 104, the decoding-processing scheduling unit 211 stays on standby until vacancy occurs.

The depth (the number of queues that can be set) of the buffer (the queue storing unit) 104 is preferably determined according to a processing ability of a decoder unit. For example, if the depth is set to a number corresponding to the number of frames that can be decoded by the decoding unit 105 within a one-frame display period sec) of the display unit 108, stall due to a mistake can be minimized.

Referring back to FIG. 4, the explanation about the processing sequence is continued. After the decoding scheduling processing by the decoding-processing scheduling unit 211 of the control unit 109, in step S102, the decoding-processing requesting unit 212 of the control unit 109 requests, according to the sequence set by the decoding-processing scheduling unit 211, the decoding unit 105 to perform decoding. This request is performed according to the order of queues set in the buffer (the queue storing unit) 104 shown in FIG. 3.

In step S103, the decoding unit 105 executes decoding processing in order of the request from the decoding-processing requesting unit 212 of the control unit 109. A decoding result is stored in the frame buffer 106.

Next, in step S104, the display-frame selecting unit 213 of the control unit 109 outputs selection information of display frames to the display control unit 107. The display-frame selecting unit 213 selects, according to a completion state of the decoding processing, frame data to be displayed. A specific processing example is explained later.

In step S105, the display control unit 107 executes output of the decoded frame image to the display unit 108 according to the frame information designated by the display-frame selecting unit 213 of the control unit 109.

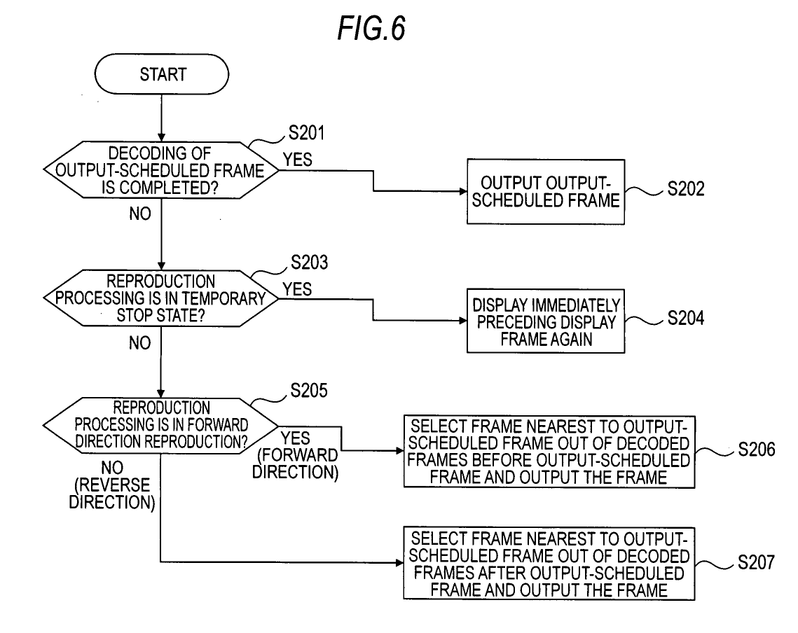

A sequence of display frame selection processing executed by the display-frame selecting unit 213 is explained with reference to a flowchart shown in FIG. 6.

The display-frame selecting unit 213 input with display-scheduled frame information set by the decoding-processing scheduling unit 211 and decoding processing information (processing completion information) of the decoding unit 105 and further input with display (reproduction) status information (high-speed reproduction (how many times as high as normal speed), a reproducing direction (a forward direction or a reverse direction), whether the display unit 108 is in a temporary stop state, etc.) in the display unit 108 and performs selection processing for display frames.

First, in step S201, the display-frame selecting unit 213 determines, on the basis of the display-scheduled frame information set by the decoding-processing scheduling unit 211 and the decoding processing information (the processing completion information) of the decoding unit 105, whether decoding processing for the next output-scheduled frame is completed and the frame can be output. When the decoding processing is completed and the frame can be output, the display-frame selecting unit 213 proceeds to step S202 and executes processing for outputting the output-scheduled frame to the display unit 108 as planned.

On the other hand, when the decoding processing for the output-scheduled frame is not completed and the frame may not be able to be output, the display-frame selecting unit 213 proceeds to step S203. In step S203, the display-frame selecting unit 213 checks whether a display status (a reproduction form) in the display unit 108 is in a temporary stop state. The temporary stop state is a continuous display state of the same frame. In this case, the display-frame selecting unit 213 proceeds to step S204 and repeatedly displays a frame being subjected to display processing.

On the other hand, when the display processing is not in the temporary stop state, the display-frame selecting unit 213 proceeds to step S205. In step S205, the display-frame selecting unit 213 checks whether reproduction processing is forward direction reproduction or reverse direction reproduction. When the reproduction processing is the forward direction reproduction, the display-frame selecting unit 213 proceeds to step S206.

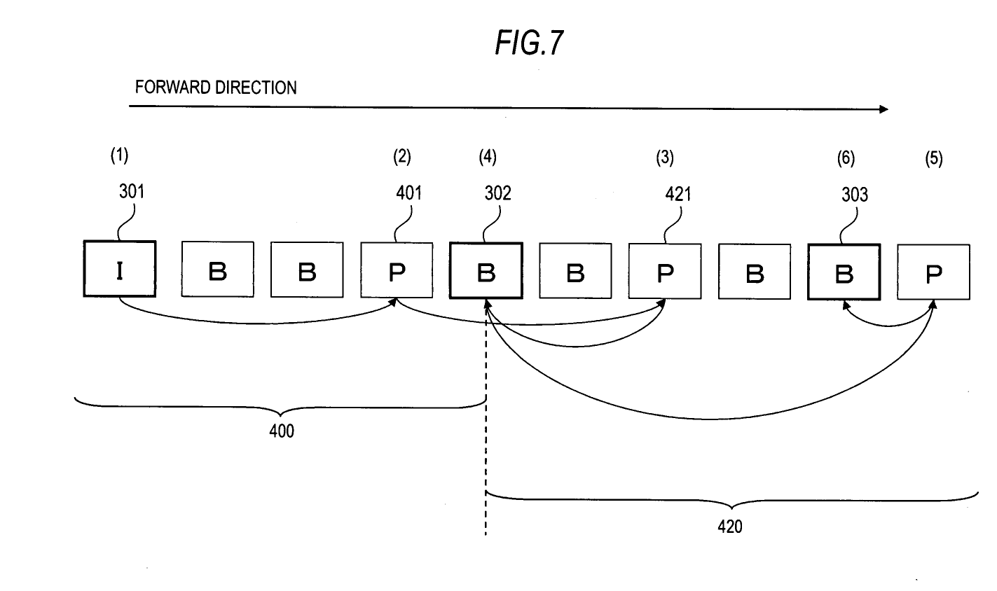

In step S206, the display-frame selecting unit 213 selects a frame nearest to the output-scheduled frame out of decoded frames before the output-scheduled frame and outputs the frame. For example, an example of this processing is explained with reference to FIG. 7 similar to FIG. 5. In the example shown in FIG. 7, when the B picture 302 is an output-scheduled frame, it is assumed that decoding of the B picture 302 is not completed.

In this case, a decoded picture frame is selected as a display target out of preceding frames 400 before the B picture 302. For example, in the example shown in FIG. 7, decoding is performed in order of (1) to (6). Therefore, even if decoding of the B picture 302 is not completed, decoding of a P picture 401 may be completed. In this case, the P picture 401 is selected as a display frame and displayed as an alternative frame of the B picture 302. When the decoding of the P picture 401 is not completed either, the I picture 301 is displayed.

In this way, in step S206, the display-frame selecting unit 213 selects a frame nearest to the output-scheduled frame out of decoded frames before the output-scheduled frame and outputs the frame.

When it is determined in step S205 that the reproduction processing is the reverse direction processing, the processing proceeds to step S207. In step S207, the display-frame selecting unit 213 selects a frame nearest to the output-scheduled frame out of decoded frames after the output-scheduled frame and outputs the frame.

For example, in the example shown in FIG. 7 explained above, when the B picture 302 is an output-scheduled frame, if decoding of the B picture 302 is not completed, decoded pictures of following frames 420 after the B picture 302 is selected as display frames. For example, a P picture 421 is selected as a display frame and displayed as an alternative frame of the B picture 302.

In this way, the display-frame selecting unit 213 of the control unit 109 searches for a decoded frame from a frame buffer and, when the frame is found, selects the frame as a display frame. When the frame is not found (decoding is not completed), according to reproducing speed at that point, the display-frame selecting unit 213 selects frames explained below.

In the temporary stop state: display an immediately preceding displayed frame again until the decoding of the frame is completed.

During the forward direction reproduction: select a frame nearest to the frame in a range of frames further in the past than the frame out of the decoded frames

During the revere direction reproduction: select a frame nearest to the frame in a range of a frame further in future than the frame out of the decoded frames.

By selecting the display frames in this way, it is possible to prevent the display frames from progressing in an unintended direction, for example, when the reproduction processing returns to the temporary stop state from the forward direction reproduction.

By performing such decoding and display control, it is possible to realize a simple reproduction processing apparatus that suppresses fluctuation in reproducing speed during high-speed reproduction, responds to interaction of a user with low delay, and can operate in the same algorithm regardless of a reproducing direction and speed.

The reproducing speed and the reproducing direction can be changed by user operation. According to information concerning the user operation, the control unit 109 dynamically changes and determines a decoding sequence and display frames. The display-frame selecting unit 213 selects a most suitable frame out of frames for which decoding is completed at every display timing.

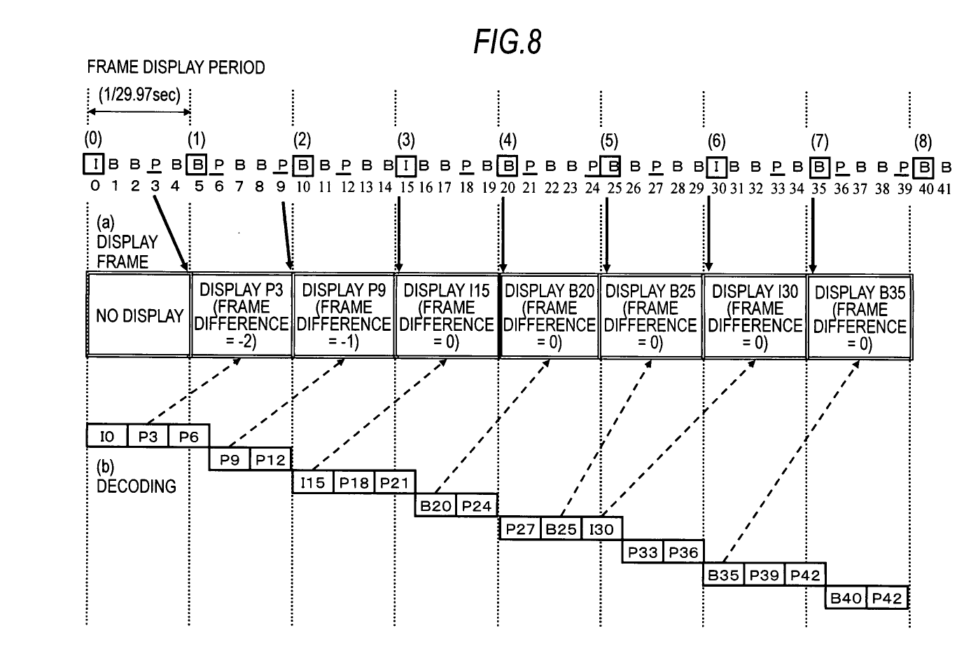

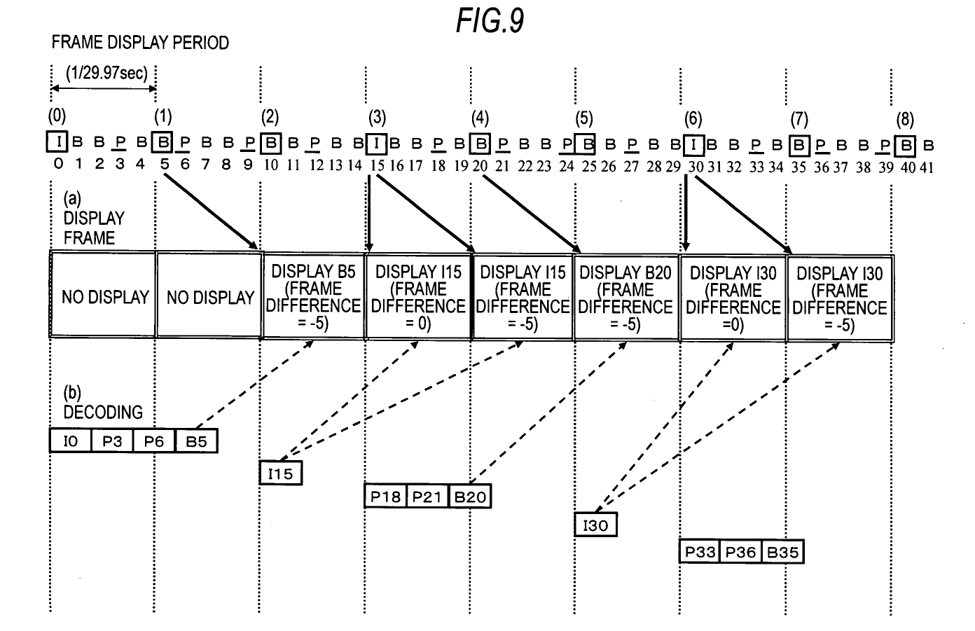

A difference between the decoding and the display processing by the reproduction processing apparatus according to this embodiment and the decoding processing in the past is explained with reference to FIGS. 8 and 9. As an example of coded data as a target of decoding processing, the decoded data has a GOP structure IBBPBBPBB . . . (open GOP) and is reproduced at quintuple-speed.

FIG. 8 is a decoding and display sequence conforming to a processing system according to this embodiment.

FIG. 9 is a decoding and display sequence conforming to a processing system in the past.

First, the decoding and display sequence conforming to the processing system according to this embodiment is explained with reference to FIG. 8. A picture sequence forming decoding target MPEG data is shown in an upper part of FIG. 8. IBBPBBPBB . . . indicate picture types. The pictures are pictures with picture Nos. 0 to 41. When the quintuple-speed reproduction is performed, reproduction scheduled frames are decoded frames of pictures corresponding to time (0) to time (8) shown in the figure.

I picture
B picture
B picture
I picture
B picture
B picture
I picture
B picture
B picture

If decoded frames of these pictures can be displayed at time (0) to time (8), complete quintuple-speed reproduction and display is performed. This means that, when these frames are sequentially displayed in a one-frame display period (1/29.97 sec) unit, quintuple-speed display is executed.

However, when decoded frames of pictures scheduled to be displayed at time (0) to time (8) are generated, concerning I pictures, decoding processing for only the I pictures has to be performed. However, when decoded frames of B pictures or P pictures are generated, decoding processing for reference pictures other than the pictures is also necessary.

P pictures indicated by underlines shown in the figure are pictures that need to be decoded as reference frames when decoded frames of the B pictures included in time (0) to time (8) are generated.

In setting shown in FIG. 8, display processing for decoded frames of IBB pictures is repeated at time (0) to time (8). Therefore, in order to surely display all display-scheduled frames, it is necessary to decode seven pictures (IPPBPPB) in a three-frame display period for IBB. Therefore, decoding processing speed of a logical decoding unit that are necessary for executing the quintuple-speed display processing of the setting shown in FIG. 8 is decoding processing speed about 7/3 times or more as high as display speed. However, decoding time is different depending on a picture status. It is not guaranteed that decoding can follow reproduction and display processing at this decoding speed.

An example of a timing chart shown in FIG. 8 is a timing chart set by assuming that decoding processing speed of the decoding unit 105 is 2.5 times as high as display speed and decoding processing times for the respective pictures are equal. In other words, the decoding unit 105 can execute decoding of pictures equivalent to 2.5 frames in a one-frame display period (1/29.97 sec). The depth of queues that can be set as queues for pictures in the decoding unit 105 is three stages.

The decoding and display sequence conforming to the processing system according to this embodiment is explained with reference to FIG. 8.

In FIG. 8, data of (a) frames (pictures) actually displayed in the decoding and display sequence conforming to the processing system according to this embodiment and (b) a decoding processing sequence are shown.

As explained above, in the reproduction processing apparatus 100 according to this embodiment, the decoding-processing scheduling unit 211 of the control unit 109 sequentially sets decoding target pictures necessary for display of display frames in future in queues when vacancy occurs in a queue. Therefore, the decoding processing is executed by the decoding unit 105 without a pause as indicated by a decoding processing sequence shown in (b) of FIG. 8.

Processing at each time performed when display and decoding processing of quintuple-speed high-speed reproduction is started from time (0) is explained below.

### [Time [0]]

A display-scheduled picture at the point of time (0) is an I picture (I0) with a picture No. 0. However, since decoding of the I picture (I0) is not completed, display of the I picture (I0) is not executed.

A picture scheduled to be displayed at time (1) as the next display timing is a B picture (B5) with a picture No. 5. For display of the B picture (B5), it is necessary to decode reference pictures (P3) and (P6) before and after the B picture (B5) earlier.

Therefore, when decoding processing and display processing are started from time (0), the decoding unit 105 needs to decode the pictures in order of I0, P3, P6, and B5 from time (0).

However, because the depth of queues that can be set as queues for pictures in the decoding unit 105 is three stages, first, at time (0), three pictures I0, P3, and P6 are set in the queues (the buffer (the queue storing unit) 104 shown in FIG. 3). The decoding unit 105 executes the decoding processing in order (I0, P3, and P6) from the top of the queues. One square shown in the section of decoding in (b) of FIG. 8 indicates decoding processing time for one frame (picture) of the decoding unit 105.

In this sequence example, as explained above, the decoding unit 105 executes decoding of pictures equivalent to 2.5 frames in the one-frame display period (1/29.97 sec). Therefore, in a period of time (0) to time (1), decoding is completed for the two pictures I0 and P3 among the three pictures I0, P3, and P6 set in the queues. Time (1) comes in a decoding period for P6.

### [Time (1)]

A frame scheduled to be displayed at time (1) after the elapse of the one-frame display period (1/29.97 sec) from time (0) is the B picture (B5).

However, since decoding of the B picture (B5) is not completed at time (1), the B picture (B5) may not be able to be displayed.

In this case, as explained as the processing in step S206 of the flow shown in FIG. 6, the display-frame selecting unit 213 selects a frame in the past nearest to the output-scheduled frame (the B picture (B5)) out of decoded frames before the output-scheduled frame and outputs the frame. In the example shown in FIG. 8, frames for which decoding is completed at the point of time (1) are only I0 and P3. A frame in the past nearest to the output-scheduled frame (B5) among the frames 10 and P3 is the picture (P3). Therefore, a decoded frame of the picture (P3) is displayed in the one-frame display period (1/29.97 sec) from the point of time (1).

As shown in (a) of FIG. 8, the picture (P3) is displayed in a period of time (1) to time (2). The picture frame (P3) is a preceding frame second immediately preceding the display-scheduled picture (B5) during the original quintuple-speed reproduction. In (a) in FIG. 8, a frame difference between an original display-scheduled frame and an actually displayed frame is shown as a frame difference. The display frame difference in the period of time (1) to time (2) is (−2). (−2) indicates that the actual display frame (P3) is a frame second immediately preceding the display-scheduled picture (B5). A frame in future is represented as (+) and a frame in the past is represented as (−).

The display frame selection processing by the display-frame selecting unit 213 of the control unit 109 is repeatedly executed at every switching time of respective display frames. In other words, the display frame selection processing following the flowchart explained with reference to FIG. 6 above is repeatedly executed at every display timing. In the example shown in FIG. 8, the display frame selection processing is performed at times (0), (1), (2), . . . or right before the times.

The queue setting processing for the buffer (the queue storing unit) 104 by the decoding-processing scheduling unit 211 of the control unit 109 is sequentially performed according to a vacancy state of a queue. It is determined, according to setting information of the decoding-processing scheduling unit 211 and queue setting timing, which picture should be set as a queue. In other words, decoded pictures necessary for display of display-scheduled frames in future not displayed at timing when a new queue is set are sequentially set in queues.

The decoding-processing scheduling unit 211 of the control unit 109 determines a sequence of decoding target pictures among pictures necessary for displaying display-scheduled frames in future and sets queues indicating that the decoding target pictures are decoding waiting pictures in the buffer (the queue storing unit) 104. According to this queue setting, the decoding unit 105 can continuously execute decoding processing without a pause as long as a queue is present.

In this example, I0, P3, and 06 are set in queues at the timing of time (0). The decoding unit 105 sequentially executes decoding processing from the top of the queues. Decoding of I0 and P1 is completed in a period of time (0) to time (1). Time (1) comes during decoding of P6.

In a period of time (1) to time (2), decoded pictures necessary for display of display-scheduled frames in future are decoded pictures necessary for display of display-scheduled frames after time (2). These pictures are set in queues.

In the example shown in the figure, a display-scheduled frame at time (2) is a picture (B10) with a picture No. I0. Decoding target pictures necessary for display processing for the picture B10 are B9, B12, and B10. Since the picture (P6) for which decoding is not finished yet is left in the queues, two queues for P9 and P12 are sequentially set.

### [Time (2)]

A display-scheduled frame at time (2) after the elapse of the one-frame display period (1/29.97 sec) from time (1) is the B picture (B10).

However, at time (2), since decoding of the B picture (B10) is not completed, the B picture (B10) may not be able to be displayed. Decoding is completed up to P9 and P12 at time (2).

In this case, as explained above as the processing in step S206 of the flow shown in FIG. 6, the display-frame selecting unit 213 performs processing for selecting a frame in the past nearest to the output-scheduled frame [the B picture (B10)] out of decoded frames before the output-scheduled frame [the B picture (B10)] and outputting the frame. In the example shown in FIG. 8, a decoded picture in the frame in the past nearest to the output-scheduled frame (B10) is the picture (P9). Therefore, display of a decoded frame of the picture (P9) is executed in the one-frame display period (1/29.97 sec) from the point of time (2).

As shown in (a) in FIG. 8, the picture (P9) is displayed in a period of time (2) to time (3). This picture (P9) is a frame immediately preceding the display-scheduled picture (B10) during the original quintuple-speed reproduction. A display frame difference in the period of time (2) to time (3) is (−1).

The decoding-processing scheduling unit 211 of the control unit 109 performs new queue setting according to vacancy of a queue in the period of time (2) to time (3). In the period of time (2) to time (3), the decoding-processing scheduling unit 211 determines queues that are set on the basis of frames displayed at times (3), (4), . . . , which are display timing in future.

In the example shown in the figure, a display-scheduled frame at time (3) is a picture (I15) with a picture No. 15. A decoding target picture necessary for display processing for the picture I15 is only I15. Even if the picture I15 is set in a queue, queues for the remaining two pictures can be set. In this case, the decoding-processing scheduling unit 211 of the control unit 109 selects a decoding target picture necessary for display processing for a frame displayed at time (4), which is the next display timing, and sets the decoding target picture in a queue.

In the example shown in the figure, a display-scheduled frame at time (4) is a picture (B20) with a picture No. 20. Decoding target pictures necessary for display processing for the picture B20 are P18, P21, and B20. Two pictures P20 and P21 that can be set in queues are set in queues from these pictures. The decoding unit 105 performs decoding processing in order of setting in the queues.

### [Time (3)]

A display-scheduled frame at time (3) after the elapse of the one-frame display period (1/29.97 sec) from time (2) is the I picture (I15).

At time (3), decoding of the I picture (I15) is completed. Therefore, at time (3), the I picture (I15) is displayed.

As shown in (a) in FIG. 8, the picture (I15) is displayed in a period of time (3) to time (4). The picture (I15) coincides with the display-scheduled picture (I15) during the original quintuple-speed reproduction. Therefore, a display frame difference in the period of time (3) to time (4) is (0).

The decoding-processing scheduling unit 211 of the control unit 109 also performs new queue setting according to vacancy of a queue in the period of time (3) to time (4). In the period of time (3) to time (4), the decoding-processing scheduling unit 211 determines queues that are set on the basis of frames displayed at times (4), (5), . . . , which are display timing in future.

In the example shown in the figure, a display-scheduled frame at time (4) is the picture (B20) with the picture No. 20. Decoding target pictures necessary for display processing for the picture B20 are P18, P21, and B20. P18 and P21 are already set in queues. B20 is set in a queue anew. Further, a decoding target picture P24 necessary for display processing for a display-scheduled frame [a B picture (B25)] at time (5) is set according to vacancy of a queue. The decoding unit 105 performs decoding processing in order of setting in the queues.

### [Time (4)]

A display-scheduled frame at time (4) after the elapse of the one-frame display period (1/29.97 sec) from time (3) is the B picture (B20). At time (4), decoding of the B picture (B20) is completed. Therefore, at time (4), the B picture (B20) is displayed.

As shown in (a) of FIG. 8, the B picture (B20) is displayed in the period of time (4) to time (5). The B picture (B20) coincides with a display-scheduled picture during the original quintuple-speed reproduction. Therefore, a display frame difference in the period of time (4) to time (5) is (0).

The decoding-processing scheduling unit 211 of the control unit 109 also performs new queue setting according to vacancy of a queue in the period of time (4) to time (5). In the period of time (4) to time (5), the decoding-processing scheduling unit 211 determines queues that are set on the basis of frames displayed at times (5), (6), . . . , which are display timing in future.

In the example shown in the figure, a display-scheduled frame at time (5) is a picture (B25) with a picture No. 25. Decoding target pictures necessary for display processing for the picture B25 are P24, P27, and B25. P24 is already set in a queue. P27 and B25 are set in queues anew. A decoding target picture 130 necessary for display processing for a display-scheduled frame [an I picture (I30)] at time (6) is set according to vacancy of a queue. The decoding unit 105 performs decoding processing in order of setting in the queues.

### [Time (5)]

A display-scheduled frame at time (5) after the elapse of the one-frame display period (1/29.97 sec) from time (4) is an I picture (I25).

At time (5), decoding of the I picture (I25) is completed. Therefore, at time (5), the I picture (I25) is displayed.

As shown in (a) of FIG. 8, the I picture (I25) is displayed in a period of time (5) to time (6). The I picture (I25) coincides with the display-scheduled picture during the original quintuple-speed reproduction. Therefore, a display frame difference in the period of time (5) to time (6) is (0).

The decoding-processing scheduling unit 211 of the control unit 109 also performs new queue setting according to vacancy of a queue in the period of time (5) to time (6). In the period of time (5) to time (6), the decoding-processing scheduling unit 211 determines queues that are set on the basis of frames displayed at times (6), (7), . . . , which are display timing in future.

In the example shown in the figure, a display-scheduled frame at time (6) is the picture (I30) with a picture No. 30. A decoding target picture necessary for display processing for the picture 130 is I30. I30 is already set in a queue. Further, the decoding-processing scheduling unit 211 sequentially sets, according to vacancy of a queue, decoding target pictures P33, P36, and B35 necessary for display processing for a display-scheduled frame [a B picture (B35)] at time (7). The decoding unit 105 performs decoding processing in order of setting in queues.

### [Time (6)]

A display-scheduled frame at time (6) after the elapse of the one-frame display period (1/29.97 sec) from time (5) is the I picture (I30).

At time (6), decoding of the I picture (I30) is completed. Therefore, at time (6), the I picture (I30) is displayed.

As shown in (a) in FIG. 8, the I picture (I30) is displayed in a period of time (6) to time (7). The I picture (I30) coincides with the display-scheduled picture during the original quintuple-speed reproduction. Therefore, a display frame difference in the period of time (6) to time (7) is (0).

The decoding-processing scheduling unit 211 of the control unit 109 also performs new queue setting according to vacancy of a queue in the period of time (6) to time (7). In the period of time (6) to (7), the decoding-processing scheduling unit 211 determines queues that are set on the basis of frames displayed at times (7), (8), . . . , which are display timing in future.

In the example shown in the figure, a display-scheduled frame at time (7) is a picture (B35) with a picture No. 35. Decoding target pictures necessary for display processing for the picture B35 are P33, P36, and B35. P33 and P36 are already set in queues. P35 is set in a queue anew. Further, the decoding-processing scheduling unit 211 sets, according to vacancy of a queue, decoding target pictures P39 and P42 necessary for display processing for a display-scheduled frame [a B picture (B40)] at time (8). The decoding unit 105 performs decoding processing in order of setting in queues.

Thereafter, the decoding-processing scheduling unit 211 repeats the same processing. In this way, the decoding-processing scheduling unit 211 of the control unit 109 according to this embodiment continuously sets decoding target pictures necessary for display processing for display frames in figure in queues for decoding processing by the decoding unit 105. According to this processing, the decoding processing does not have standby time and continuous processing is realized.

The display-frame selecting unit 213 of the control unit 109 selects, at time (0), (1), (2), . . . as display timing, preceding frames (in the past) near to display-scheduled frames (in the case of the forward direction reproduction) in frames subjected to the decoding processing by the decoding unit 105 and displays the frames.

The display-frame selecting unit 213 performs the processing explained above. In the reverse direction reproduction, the display-frame selecting unit 213 selects following frames (in future) near to display-scheduled frames and displays the frames.

As a result, even when decoding of the display-scheduled frames is not completed at the display timing, frame data corresponding to reproduction time nearer to the display-scheduled frames is displayed. In the example shown in FIG. 8, as shown in (a) of FIG. 8, differences between the display-scheduled frames and actual display frames are as follows:

time (1) to time (2)=−2 frames
time (2) to time (3)=−1 frame
time (3) to time (4)=0 frame
time (4) to time (5)=0 frame
time (5) to time (6)=0 frame
time (6) to time (7)=0 frame
time (7) to time (8)=0 frame

A maximum shift of the frames is two frames. This means that reproduction processing substantially the same as the complete quintuple-speed high-speed reproduction is realized.

A decoding and display sequence in the general high-speed reproduction processing in the past is explained with reference to FIG. 9. The decoding and display sequence according to the processing system in the past shown in FIG. 9 is set to select a display frame at the next display timing at every display timing (times (0), (1), (2), . . . ) and sequentially set decoding target pictures necessary for the display as a decoding sequence to perform decoding processing. However, when decoding following the decoding sequence set at the preceding time is not completed, decoding processing at the next time is not executed.

For example, at time (0), the display-frame selecting unit 213 selects a display frame at time (1) and sets a decoding target picture sequence of the selected display frame as a decoding sequence to start decoding.

At time (1), the display-frame selecting unit 213 selects a display frame at time (2) and sets a decoding target picture sequence of the selected display frame as a decoding sequence to start decoding.

However, when the decoding sequence set at time (0) is not completed at time (1), decoding processing corresponding to the display frame for time (2) is omitted at time (1).

The display-frame selecting unit 213 repeatedly executes this processing.

In this decoding sequence, when decoding of a frame scheduled to be displayed at every display timing is not completed, the display-frame selecting unit 213 displays a frame displayed at the preceding display timing or a frame scheduled to be displayed.

The display-frame selecting unit 213 executes decoding and display processing according to such a sequence. Detailed processing after time (0) is explained.

### [Time (0)]

A display-scheduled picture at the point of time (0) is the I picture (I0) with the picture No. 0. However, since decoding of the I picture (I0) is not completed at this point, display is not executed.

A picture scheduled to be displayed at time (1) at the next display timing is the B picture (B5) with the picture No. 5. For display of the B picture (B5), it is necessary to decode reference pictures (P3) and (P6) before and after the B picture (B5) earlier.

Therefore, when decoding processing and display processing are started from time (0), the decoding unit 105 needs to decode the pictures in order of I0, P3, P6, and B5 from time (0).

Queues are set in this order as queues for pictures in the decoding unit 105. The decoding unit 105 executes decoding processing in order (I0, P3, P6, and B5) from the top of the queues. One square shown in the section of decoding in (b) of FIG. 9 indicates decoding processing time of the decoding unit 105.

As in the processing shown in FIG. 8, the decoding unit 105 executes decoding of pictures equivalent to 2.5 frames in the one-frame display period (1/29.97 sec). Therefore, decoding is completed for the two pictures I0 and P3 in the period of time (0) to time (1). Time (1) comes in a decoding period for P6.

### [Time (1)]

A display-scheduled frame at time (1) after the elapse of the one-frame display period (1/29.97 sec) from time (0) is the B picture (B5).

However, at time (1), since decoding of the B picture (B5) is not completed, the B picture (B5) may not be able to be displayed.

In the sequence in the past, when decoding of display-scheduled frames is not completed and pictures may not able to be displayed, the display-frame selecting unit 213 continues to display a display frame at the preceding display timing. In this example, the decoding-processing scheduling unit 211 continues to display the display frame at time (0). However, since there is no display frame at time (0), the display-frame selecting unit 213 may not be able to start display of an image at time (1) either.

In the sequence in the past, when decoding following a decoding sequence set at the preceding display time is not completed at each display time as explained above, decoding processing at the next time is not executed. In this example, decoding of the decoding sequence (I0 P3, P6, and B5) set at time (0) is not completed at time (1), decoding processing for a display frame at time (2) as the next display timing is omitted at time (1).

As a result, in the decoding processing by the decoding unit 105, as shown in (b) of FIG. 9, standby time when processing is not executed occur in various places.

### [Time (2)]

A display-scheduled frame at time (2) after the elapse of the one-frame display period (1/29.97 sec) from time (1) is the B picture (B10).

However, at time (2), since decoding of the B picture (B10) is not completed, the B picture (B10) may not be able to be displayed.

As explained above, in this sequence in the past, when decoding of a display-scheduled frame is not completed at every display timing, the decoding-processing scheduling unit 211 displays a frame displayed at the preceding display timing or a frame scheduled to be displayed. In this case, the picture (B5) as a display-scheduled frame at the preceding time (1) is displayed. Therefore, in the one-frame display period (1/29.97 sec) from the point of time (2), display of a decoded frame of the picture (B5) is executed. A display frame difference in the period of time (2) to time (3) is (−5).

At time (2), the display-frame selecting unit 213 selects a display frame at time (3) and sets a decoding garget picture sequence of the selected display frame as a decoding sequence to start decoding. A display-scheduled frame at time (3) is the picture (I15) with the picture No. 15. A decoding target picture necessary for display processing for the picture I15 is only I15.

The display-frame selecting unit 213 sets only the picture I15 as a decoding target to start decoding from time (2). In the sequence in the past, only data to be displayed at the next time is set as a decoding target. Therefore, standby time occurs even if the decoding unit 105 can perform processing.

### [Time (3)]

A display-scheduled frame at time (3) after the elapse of the one-frame display period (1/29.97 sec) from time (2) is the I picture (I15).

At time (3), since decoding of the I picture (I15) is completed, the I picture (I15) is displayed. A display frame difference at the period of time (2) to time (3) is (0).

At time (3), the display-frame selecting unit 213 selects a display frame at time (4) and sets a decoding target picture sequence of the selected display frame as a decoding sequence to start decoding. A display-scheduled frame at time (4) is the picture (B20) with the picture No. 20. Decoding target pictures necessary for display processing for the picture B20 are P18, P21, and B20.

Decoding for the pictures P18, P21, and B20 is started from time (3). However, time (4) comes during a decoding period for B20.

### [Time (4)]

A display-scheduled frame at time (4) after the elapse of the one-frame display period (1/29.97 sec) from time (3) is the B picture (B20).

At time (4), decoding of the B picture (B20) is not completed. Therefore, at time (4), the I picture (I15) as the display frame at time (3) continues to be displayed. Therefore, a display frame difference at the period of time (4) to time (5) is (−5).

As explained above, when decoding following a decoding sequence set at the preceding display time is not completed, decoding processing at the next time is not executed. In this example, decoding of the decoding sequence (P18, P21, and B20) set at time (3) is not completed at time (4). Therefore, at time (4), decoding processing for a display frame at time (5) as the next display timing is omitted.

### [Time (5)]

A display-scheduled frame at time (5) after the elapse of the one-frame display period (1/29.97 sec) from time (4) is the B picture (B25).

However, at time (5), since the decoding of the B picture (B25) is not completed, the B picture (B25) may not be able to be displayed.

As explained above, in this sequence in the past, when decoding of a frame scheduled to be displayed at every display timing is not completed, the display-frame selecting unit 213 displays a frame displayed at the preceding display timing or a frame scheduled to be displayed. In this case, the picture (B20) as the display-scheduled frame at the preceding time (4) is displayed. A display frame difference in the period of time (5) to time (6) is (−5).

At time (5), the display-frame selecting unit 213 selects a display frame at time (6) and sets a decoding target picture sequence of the selected display frame as a decoding sequence to start decoding. A display-scheduled frame at time (6) is the I picture (I30). A decoding target picture necessary for display processing for the picture 130 is only I30.

The display-frame selecting unit 213 sets only the picture 130 as a decoding target to start decoding from time (5). In the sequence in the past, only data to be displayed at the next time is set as a decoding target. Therefore, standby time occurs even if the decoding unit 105 can perform processing.

### [Time (6)]

A display-scheduled frame at time (6) after the elapse of the one-frame display period (1/29.97 sec) from time (5) is the I picture (I30).

At time (6), since decoding of the I picture (I30) is completed, the I picture (I30) is displayed. A display frame difference in the period of time (6) to time (7) is (0).

At time (6), the display-frame selecting unit 213 selects a display frame at time (7) and sets a decoding target picture sequence of the selected display frame as a decoding sequence to start decoding. A display-scheduled frame at time (7) is the picture (B35) with the picture No. 35. Decoding target pictures necessary for display processing for the picture B35 are P33, P36, and B35.

Decoding for the pictures P33, P36, and B35 is started from time (6). However, time (7) comes during a decoding period for B35. Decoding processing and display processing are executed according to such a sequence.

As it is understood by comparing FIGS. 8 and 9, whereas idle time does not occur in decoding processing in the processing sequence according to this embodiment shown in FIG. 8, decoding processing is performed at intervals and a period in which processing is not executed often occurs in the sequence in the past shown in FIG. 9.

As a result, in the sequence in the past shown in FIG. 9, as shown in (a) of FIG. 9, differences between the display-scheduled frames and the actual display frames are large. Frame differences are as follows:

time (1) to time (2)=no display
time (2) to time (3)=−5 frames
time (3) to time (4)=0 frame
time (4) to time (5)=−5 frames
time (5) to time (6)=−5 frames
time (6) to time (7)=0 frame
time (7) to time (8)=−5 frames

A maximum shift of 5 frames occurs and a difference from the complete quintuple-speed high-speed reproduction increases. As a result, a reproduced image is disordered.

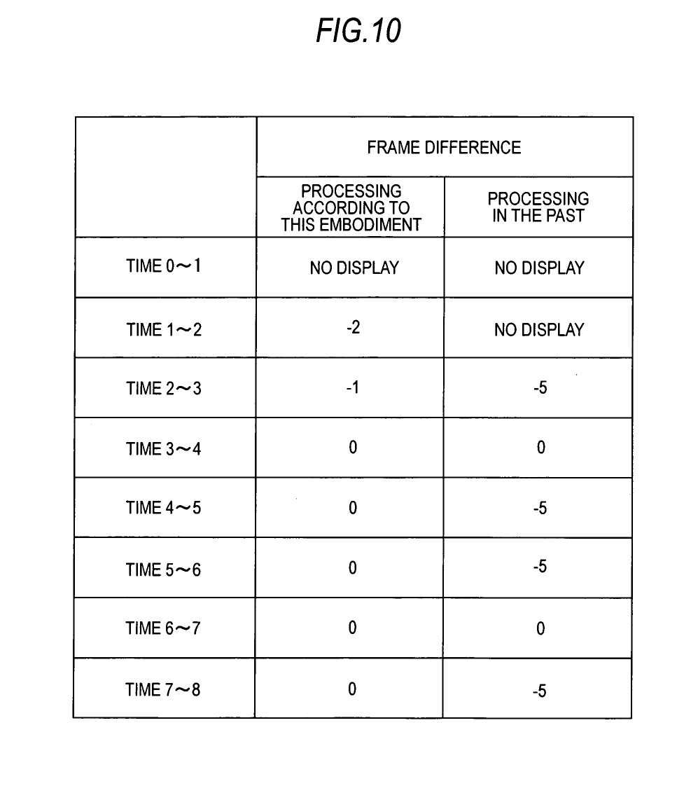

Comparison data of frame differences between display-scheduled images and actually displayed images in the decoding and reproduction processing sequence according to this embodiment explained with reference to FIG. 8 and the decoding and reproduction processing sequence according to the sequence in the past explained with reference to FIG. 9 is shown in FIG. 10. As it is understood from the comparison data shown in FIG. 10, in the processing in this embodiment, a frame difference is small compared with that in the processing in the past and a satisfactory high-speed reproduced image is obtained.

In the processing example explained with reference to FIG. 8, it is assumed that decoding processing time in the decoding unit 105 is uniform in all pictures. However, actually, it is predicted that the decoding processing time is different depending on a picture type or information included in the pictures. Therefore, the control unit 109 may acquire a picture type of a decoding schedule and, if possible, configuration information of pictures and perform decoding processing scheduling on the basis of these kinds of information.

For example, decoding processing times predicted in advance are held in such a manner as decoding processing time for an I picture is held at 8 ms, decoding processing time for an P picture is held at 5 ms, and decoding processing time for a B picture is held at 3 ms. Processing for setting a decoding sequence is performed according to these processing times.

The decoding queues shown in FIG. 8 are configured to set 2.5 decoded pictures in the one-frame display period sec). However, by taking into account the decoding processing times corresponding to the respective pictures, it is also possible to perform processing in which a large number of decoded pictures are set in the one-frame display period (29.97 sec).

The present invention has been explained in detail with reference to the specific embodiment. However, it is evident that those skilled in the art can perform alterations and substitutions of the embodiment without departing from the spirit of the present invention. The present invention has been disclosed by means of illustration and should not be limitedly interpreted. To determine the scope of the present invention, the appended claims should be taken into account.

The series of processing explained in this specification can be executed by hardware such as an integrated circuit or software or a combined form of the hardware and the software. When the processing by the software is executed, it is possible to install a computer program having a processing sequence recorded therein in a memory of a computer incorporated in hardware and cause the computer to execute the computer program or install the computer program in a general-purpose computer that can execute various kinds of processing and cause the computer to execute the computer program. For example, the computer program can be recorded on a recording medium in advance. Besides installing the computer program in a computer from the recording medium, it is possible to receive the computer program via a network such as a LAN (Local Area network) or the Internet and install the computer program in a recording medium such as a hard disk incorporated in the computer.

The various kinds of processing described in this specification may be executed not only in time series according to the description but also in parallel or individually according to a processing ability of an apparatus that executes the processing or according to necessity. In this specification, the system is a logical set of plural apparatuses and is not limited to a system in which apparatuses of respective configurations are provided in the same housing.

As explained above, according to the embodiment of the present invention, for example, in the reproduction processing apparatus, the reproduction processing method, and the computer program for performing decoding processing of MPEG coded data, the decoding-processing scheduling unit sets a sequence of decoding target data necessary for display of display-scheduled frames in future and sequentially sets, according to the sequence, queues for the decoding unit when vacancy of a queue occurs. The display-frame selecting unit checks a completion state of decoding of the display-scheduled frame at every display timing and, when the decoding is not completed, selects a decoded frame near the display-scheduled frame as a display frame. With such a configuration, for example, in high-speed reproduction processing, even when the decoding of the display-scheduled frame is not completed at every display timing, since display of a near frame is executed, high-quality image reproduction processing with little fluctuation is realized.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction processing apparatus comprising:
a decoding unit that executes decoding processing for coded data;
a decoding-processing scheduling unit that sets a sequence of the decoding processing in the decoding unit; and
a display-frame selecting unit that selects a display frame from a decoding result in the decoding unit, wherein
the decoding-processing scheduling unit sets a sequence of decoding target data necessary for display of display-scheduled frames in future and sequentially sets, according to the sequence, queues for the decoding unit when vacancy of a queue occurs, and
the display-frame selecting unit checks a completion state of decoding of the display-scheduled frame at every display timing and, when the decoding is not completed, performs processing for selecting a decoded frame near the display-scheduled frame as a display frame.

2. A reproduction processing apparatus according to claim 1, wherein the decoding-processing scheduling unit monitors vacancy of the queue and, when vacancy occurs, sequentially sets queues according to the sequence.

3. A reproduction processing apparatus according to claim 1, wherein the decoding-processing scheduling unit sets, in addition to decoding target data necessary for display of the next display-scheduled frame of a presently displayed frame, decoding target data necessary for display of a display-scheduled frame after that as queues for the decoding unit.

4. A reproduction processing apparatus according to claim 1, wherein the decoding-processing scheduling unit analyzes a display-scheduled frame at each display interval on the basis of reproducing speed and also displays decoding target data necessary for displaying decoding target data necessary for display of the display-scheduled frame as queues for the decoding unit.

5. A reproduction processing apparatus according to claim 1, wherein
the coded data is MPEG data including an I picture, a P picture, and a B picture as elements, and
the decoding-processing scheduling unit discriminates which of the I picture, the P picture, and the B picture the display-scheduled frames in future are and sets a decoding sequence according to a result of the discrimination.

6. A reproduction processing apparatus according to claim 1, wherein
the coded data is MPEG data including an I picture, a P picture, and a B picture as elements, and
the decoding-processing scheduling unit acquires decoding prediction time set in association with the I picture, the P picture, and the B picture and sets a decoding sequence according to a type of the decoding target data.

7. A reproduction processing apparatus according to claim 1, wherein the display-frame selecting unit performs, when the decoding of the display-scheduled frame is not completed at every display timing, processing for selecting a nearest decoded frame among frames in the past before the display-scheduled frame as a display frame if a display state in the display unit is forward-direction reproduction processing and performs processing for selecting a nearest decoded frame among frames in future after the display-scheduled frame as a display frame if the display state in the display unit is reverse-direction reproduction processing.

8. A reproduction processing apparatus according to claim 1, wherein the display-frame selecting unit performs, when the decoding of the display-scheduled frame is not completed at every display timing, display frame selection processing for continuing to display an immediately preceding display frame if the display state in the display unit is a temporary stop state.

9. An integrated circuit comprising:
a decoding unit that executes decoding processing for coded data;
a decoding-processing scheduling unit that sets a sequence of the decoding processing in the decoding unit; and
a display-frame selecting unit that selects a display frame from a decoding result in the decoding unit, wherein
the decoding-processing scheduling unit sets a sequence of decoding target data necessary for display of display-scheduled frames in future and sequentially sets, according to the sequence, queues for the decoding unit when vacancy of a queue occurs, and
the display-frame selecting unit checks a completion state of decoding of the display-scheduled frame at every display timing and, when the decoding is not completed, performs processing for selecting a decoded frame near the display-scheduled frame as a display frame.

10. A reproduction processing method executed in a reproduction processing apparatus, the reproduction processing method comprising the steps of:
a decoding unit executing decoding processing for coded data;
a decoding-processing scheduling unit setting a sequence of the decoding processing in the decoding unit; and
a display-frame selecting unit selecting a display frame from a decoding result in the decoding unit, wherein
the decoding-processing scheduling step includes a step of setting a sequence of decoding target data necessary for display of display-scheduled frames in future and sequentially setting, according to the sequence, queues for the decoding unit when vacancy of a queue occurs, and
the display-frame selecting step includes a step of checking a completion state of decoding of the display-scheduled frame at every display timing and, when the decoding is not completed, performing processing for selecting a decoded frame near the display-scheduled frame as a display frame.

11. A computer program for causing a reproduction processing apparatus to execute reproduction processing, the computer program comprising the steps of:
a decoding unit executing decoding processing for coded data;
a decoding-processing scheduling unit setting a sequence of the decoding processing in the decoding unit; and
a display-frame selecting unit selecting a display frame from a decoding result in the decoding unit, wherein
the decoding-processing scheduling step includes a step of setting a sequence of decoding target data necessary for display of display-scheduled frames in future and sequentially setting, according to the sequence, queues for the decoding unit when vacancy of a queue occurs, and
the display-frame selecting step includes a step of checking a completion state of decoding of the display-scheduled frame at every display timing and, when the decoding is not completed, performing processing for selecting a decoded frame near the display-scheduled frame as a display frame.
